(19) United States
(12) Patent Application Publication
(10) Pub. No.: US 2008/0296851 A1
(43) Pub. Date: Dec. 4, 2008

(54) Hands-free towing apparatus for strollers, pet carriers and other carriages

(76) Inventor: Lisa Marie Hall, Pine, CO (US)

Correspondence Address: Lisa Marie Hall, 33654 Smith Rd., Pine, CO, 80470, US

(21) Appl. No.: 12/156,359

(22) Filed: May 30, 2008

Related U.S. Application Data
(60) Provisional application No. 60/932,235, filed on May 31, 2007.

(51) Int. Cl. B62B 9/00

(52) U.S. Cl. 280/1.5

(57) ABSTRACT

A hands-free towing apparatus fro strollers, pet carriers and other carriages is described. The apparatus comprises a belt-attachment device, a frame, and a carriage-attachment device. The belt-attachment device can be a padded belt attached to a formed back-plate that a caregiver wears on his or her torso. A frame having a first end and a second end joins the belt-attachment device and the carriage-attachment device. A lockable joint can be incorporated within the frame to allow the apparatus to fold. The first end of the frame attaches to the belt-attachment device via a joint mechanism. The frame extends back from the caregiver to a carriage where the second end of the frame attaches to the carriage via the carriage attachment device.

### CROSS-REFERENCE TO RELATED APPLICATIONS

This application claims benefit of U.S. Provisional Application No. 60/932,235, entitled “Joggy Doggy Apparatus for Pulling Strollers” and filed on May 31, 2007, which is specifically incorporated herein by reference for all that it discloses and teaches.

### TECHNICAL FIELD

The invention relates generally to the strollers and pet carriers industries and more particularly to an apparatus for towing strollers, pet carriers and other carriages.

### BACKGROUND

There are many types of strollers, baby buggies, and rolling pet carriers (collectively, carriages) on the market today. Such devices are designed to carry babies, small children, or pets (collectively, occupants) in a comfortable position so that the occupants' caregiver can comfortably walk or jog with the occupants without requiring the occupants to walk or jog themselves. Some carriages are only designed for one occupant, while others provide for multiple occupants. These carriages are mounted on one or more wheels and are meant to be pushed or pulled by the caregiver as distinguished from those devices that do not have wheels and are designed to assist the caregiver in carrying the occupant(s).

Traditional carriages usually have one or more handles that the caregiver is required to grasp in his or her hands. The handles allow the caregiver to propel the carriage forward and maintain control over its speed and direction. However, using one or both hands to grasp a handle limits the caregiver's ability to use their hands for other tasks. This becomes especially problematic when the caregiver wishes to jog or run while pushing a traditional carriage as the natural jogging movement and position of the arms—arms bent at the elbows and swinging alternately back and forth in rhythm with the steps—are either completely impossible or at least difficult to do while holding one or more handles and pushing a carriage.

A somewhat recent development in the art has been the emergence of a jogging carriage with higher handles and larger wheels to assist in safely transporting occupants while the caregiver is jogging or walking over rougher terrain. In addition, the problems posed by hand-grasped handles have been addressed to some degree by devices which attach between the caregiver's waist and the carriage allowing the carriage to be pushed by the caregiver's body and thereby freeing the caregiver's hands and arms. Nevertheless, such push-type, hands-free jogging carriages have a number of problems of their own.

One difficulty with push-type, hands-free carriages is that the position of the carriage in front of the caregiver limits the field-of-view of the caregiver. For example, there are many hazards encountered by a jogger such as pot-holes, road debris, rocks, etc. Such hazards may not be visible to the caregiver until he or she is in close proximity thereto, especially when the hazards are small or otherwise hard to distinguish. However, when the caregiver is pushing a carriage, the carriage may block the caregiver's field of view so that such hazards are not seen and can not be avoided, resulting in harm to the caregiver and/or the occupant. A second significant problem with push-type, hands-free carriages is that if a caregiver falls or trips while attached to the carriage via the hands-free apparatus, the carriage can be tipped over, the occupant can be severely tossed about, the caregiver can land on the carriage or the hands-free apparatus, or a combination of those potentially harmful events can occur. Another difficulty inherent in push-type carriages is that sharp turns and other rapid maneuvers can be difficult to accomplish safely.

In order to address some of these problems, a few pull-type carriages have been designed. For example, U.S. Pat. No. 5,062,651 to Varieur discloses a pull-type carriage. However, such carriages have introduced other problems, including being overly bulky and heavy. Additionally, the Varieur carriage is integrated with the towing means and thus requires that the caregiver own an additional carriage for use when not jogging and when in confined areas such as stores, malls, etc. The Varieur pull-type carriage also has does not fully address the problems that can occur when the caregiver falls while pulling the carriage, e.g. the occupant is violently tossed forward and the carriage can easily tip. Because the Varieur device uses two pull-handles which are attached to the caregivers sides, rapid turns and maneuvers to avoid obstacles or hazards are not possible.

Therefore, a carriage pulling apparatus is needed that will address all of the above problems in current push-type and pull-type carriage assemblies.

### SUMMARY

Embodiments of the present invention described and claimed herein address the foregoing limitations and problems by providing a pull-type, hands-free apparatus for towing a carriage. Multiple types of carriages can be used with the apparatus as a universal attachment device is contemplated, thereby allowing a person (the caregiver) to comfortable tow a baby carriage, child stroller or pet carrier behind him or her while walking, jogging or running.

In one embodiment, a hands-free towing apparatus for strollers, pet carriers and other carriages comprises a belt-attachment device, a frame, and a carriage-attachment device. The belt-attachment device can be a padded belt attached to a formed back-plate that a caregiver wears on his or her torso. One end of a frame attaches to the belt-attachment device via a joint mechanism. The frame extends back from the caregiver to a carriage where the other end of the frame attaches to the carriage via the carriage attachment device.

The present invention provides many benefits over the prior art. Because it is a hands-free device, a user can walk, jog or run with a carriage and his or her hands and arms are able to swing naturally. Since the carriage is able to be towed instead of pushed, the caregiver's field of view remains unobstructed, thereby allowing the caregiver to see approaching obstacles and hazards. In order to avoid hazards that are seen, quick motions and changes of direction can be necessary. The present invention allows a caregiver to make abrupt, 90 degree course corrections without tipping or unduly jostling the carriage. An additional advantage of the present invention over the prior art is that if a caregiver happens to fall while he or she is using the carriage-towing apparatus, the carriage simply comes to a stop, rather than suddenly tipping, pitching or twisting. The carriage is also unable to roll away from the caregiver.

### BRIEF DESCRIPTION OF THE DRAWINGS

The aforementioned and other features and objects of the present invention and the manner of attaining them will become more apparent and the invention itself will be best understood by reference to the following descriptions of a preferred embodiment and other embodiments taken in conjunction with the accompanying drawings, wherein:

FIG. 1 illustrates a side view of an exemplary embodiment of a hands-free towing apparatus for strollers, pet carriers and other carriages.

FIG. 2 illustrates a top view of an exemplary embodiment of a hands-free towing apparatus for strollers, pet carriers and other carriages.

FIG. 3 illustrates a close-up, top view of a lockable joint in a frame of a hands-free towing apparatus for strollers, pet carriers and other carriages.

### DETAILED DESCRIPTION

In one embodiment, a hands-free towing apparatus for strollers, pet carriers and other carriages comprises a belt-attachment device, a frame, and a carriage-attachment device. The belt-attachment device can be a padded belt attached to a formed back-plate that a caregiver wears on his or her torso. In another embodiment, the belt-attachment device comprises an adjustable girdle-shaped device that distributes the carriage-pulling forces across a wide area of the caregiver's torso. In yet another embodiment, a harness device is worn, e.g., a chest harness with shoulder straps.

One end of a frame attaches to the belt-attachment device via a joint mechanism. In one embodiment, the joint mechanism comprises a bolt and a rotatable member placed perpendicular over the bolt and extending along a line in two directions. Alternatively, the rotatable member can be curved or otherwise shaped so that it does not extend along a line exactly but either approximates such or has a more three dimensional, plate-shaped form. The bolt is mounted on the belt-attachment device and extends generally perpendicular relative to the plane of the caregiver's back and away from the caregiver. The rotatable member is mounted on the bolt and can rotate in a plane perpendicular to the bolt and roughly parallel to the back-plate. The rotatable member attaches to the frame with rotating joints to allow the frame to swing in an arc up and down relative to the back-plate. The bolt can be allowed to swivel in both the back-plate and the rotatable member allowing the caregiver to turn sharply. In addition, telescoping components can be added to the frame to further facilitate turning.

In another embodiment, the joint mechanism is a universal joint, thereby allowing the frame to swing in a 180 degree arc from one side of the caregiver to the other. Furthermore, the universal joint allows the frame to swing in a 180 degree arc from the feet of the caregiver to his or her head so that the caregiver can lay flat on either his or her stomach or back and remain connected to, and in control of, the apparatus. The universal joint also allows combined movement in both arcs simultaneously.

The frame has a first end and a second end where the first end is connected to the joint mechanism and the second end is attached to a carriage. In one embodiment, the first end of the frame attaches to the rotatable member of the joint mechanism. In another embodiment, the frame attaches to the universal joint of the joint mechanism. The frame extends back from a caregiver to a carriage. The frame can be made so that it has a lockable joint that allows the frame to be folded for easy storage.

In one embodiment, the frame comprises two or more elongated tubular members extending from the joint mechanism parallel to each other. One or more horizontal stabilizers can extend from one tubular member to the other to provide rigidity and support. The tubular members can have a cross section that is round, square, rectangular, or any other shape. Furthermore, the members can be solid or hollow and can be made of metal, plastic, or any other suitable material, including, but not limited to: copper pipe, polyvinyl chloride (PVC) pipe, steel tubing, etc. In an alternate embodiment, the frame comprises a single elongated member extending from the joint mechanism to a carriage.

The second end of the frame attaches to a carriage via the carriage attachment device. In one embodiment, the carriage attachment device comprises two clamping devices. Each clamping device is shaped so as to clamp onto a structural member on each side of the carriage. Each clamping device has a bolt extending out to the side of the carriage, generally perpendicular to a line extending from the front to the rear of the carriage and relatively close to the carriage's center of gravity. Two carriage-attachment portions of the frame extend to either side of the carriage and attach to the bolts on the clamping devices. Removable lock-pins can secure the carriage-attachment portions of the frame on the bolts. The carriage-attachment portions of the frame can be configured so that they are able to rotate on the bolts, thereby allowing the frame to move in an arc up and down. This configuration offers the caregiver much more control over the carriage while also stabilizing the carriage and reducing the possibility of roll over.

In an alternate embodiment, the carriage attachment device comprises two bolt and lock-pin assemblies wherein holes are drilled through the structural members on each side of the carriage and the bolts are inserted through the structural members and through the carriage-attachment portions of the frame. The lock pins are then inserted into/over the ends of the bolts thereby locking the frame onto the bolts. In yet another embodiment, the carriage attachment device provides a means for attaching the frame to the carriage in a single location on the carriage. Furthermore, a frame attachment device can be configured to all the carriage to swivel relative to the frame.

While in use, the apparatus tends to flex and bounce, depending on the speed and movements of the walking/jogging caregiver. In one embodiment, the apparatus is constructed so as to be flexible and absorb and dampen the unnecessary motions of the apparatus. In another embodiment, rubber or some other dampening material is incorporated within the apparatus. In yet another embodiment, shock absorbing components are incorporated to reduce sharp jolts and other unwanted motions that would otherwise be transmitted between the caregiver and the carriage.

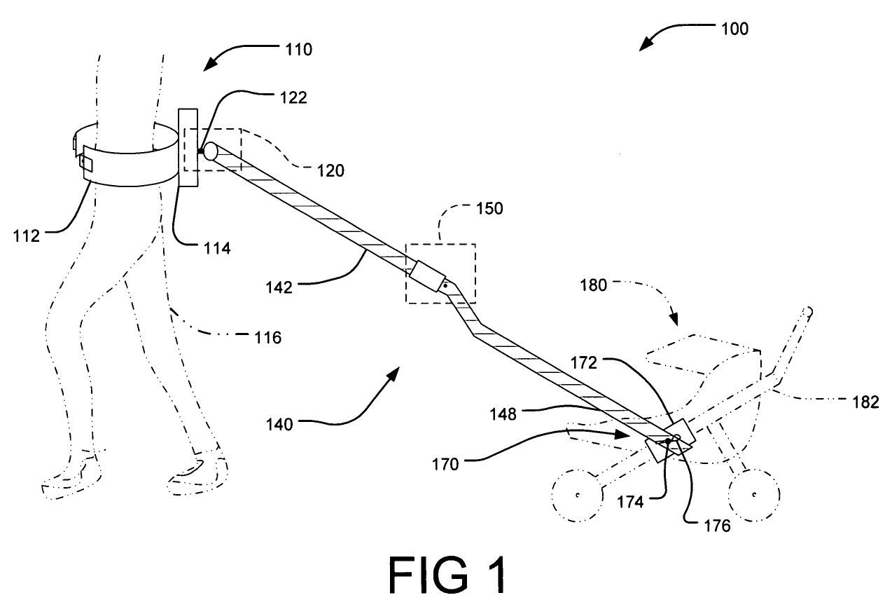

FIG. 1 illustrates a side view of an exemplary embodiment of a hands-free towing apparatus 100. The primary components shown in FIG. 1 include: a belt-attachment device 110, a frame 140, and a carriage-attachment device 170.

As shown in the embodiment in FIG. 1, the belt-attachment device 110 is a padded belt 112 attached to a formed back-plate 114 that a caregiver 116 wears around his or her waist. The back-plate 114 can be ergonomically shaped so as to comfortably fit across the caregiver's 116 lower back. The back-plate 114 can be padded with rubber, foam, etc. and can be covered in vinyl or any other comfortable material. In another embodiment, the belt-attachment device 110 comprises an adjustable girdle-shaped device that distributes the carriage-pulling-forces across a wide area of the caregiver's 116 torso. In yet another embodiment, the belt-attachment device 110 comprises a chest harness with shoulder straps and a back-plate 114.

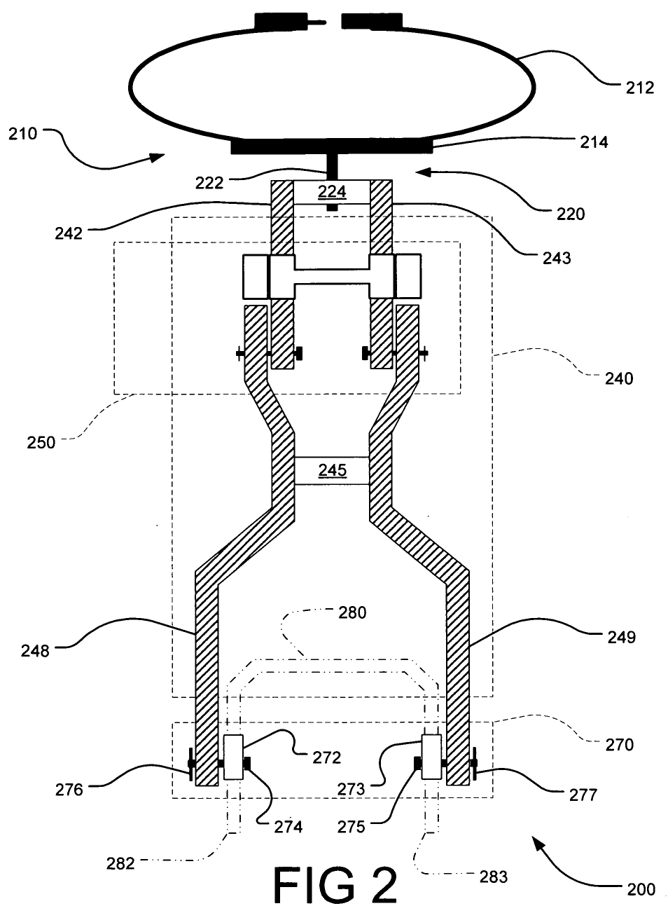

The frame 140 attaches to the belt-attachment device 110 via a joint mechanism 120. In the embodiment shown in FIG. 1, the joint mechanism 120 comprises a bolt 122 and a rotatable member (not shown in FIG. 1, see FIG. 2) extending perpendicular from the bolt 122 along a line extending in two directions. The rotatable member can be a straight, cylindrically-shaped tube. Alternatively, the rotatable member can be curved or otherwise shaped so that it does not extend along a line exactly but either approximates such or has a more three dimensional, plate-shaped form. Furthermore, the rotatable member could be formed as a solid piece rather than as a hollow tube.

The bolt 122 is mounted on the belt-attachment device 110 and extends generally perpendicular relative to the plane of the caregiver's 116 back and away from the caregiver 116. The rotatable member is mounted on the bolt 122 and can rotate in a plane perpendicular to the bolt 122. The rotatable member attaches to the frame 140. The bolt 122 can be mounted so as to swivel relative to the back-plate 114 and relative to the rotatable member in order to facilitate tight turns by the caregiver 116.

In another embodiment, the joint mechanism 120 is a universal joint, thereby allowing the frame 140 to swing in a one hundred and eighty degree arc from one side of the caregiver 116 to the other. Furthermore, the universal joint allows the frame 140 to swing in a one hundred and eighty degree arc from the feet of the caregiver 116 to his or her head so that the caregiver 116 can lay flat on either his or her stomach or back and remain connected to, and in control of, the apparatus 100. The universal joint also allows combined movement in both arcs simultaneously.

The frame 140 has a first end and a second end where the first end is connected to the joint mechanism 120 and the second end is attached to a carriage 180. In one embodiment, the first end of the frame 140 attaches to a rotatable member of the joint mechanism 120. In this embodiment, the frame 140 can attach via rotating joints to the rotatable member. In another embodiment, the frame 140 attaches to a universal joint in the joint mechanism 120. In yet another embodiment, the frame 140 attaches to a rotatable member which is attached to a universal joint within the joint mechanism 120. The frame 140 extends back from a caregiver 116 to a carriage 180. The frame 140 can be made so that it has a lockable joint 150 that allows the frame 140 to be folded for easy storage. In order to allow the frame 140 to fold flat, the frame 140 may need to incorporate some slightly angled components.

In the embodiment shown in FIG. 1, the frame 140 comprises two or more elongated tubular members 142 (only one member is shown in FIG. 1) extending from the joint mechanism 120 parallel to each other and back towards the carriage 180. One or more horizontal stabilizers (not shown in FIG. 1, see FIG. 2) can extend from one tubular member 142 to the other to provide rigidity and support. The tubular members 142 can have a cross section that is round, square, rectangular, or any other shape. Furthermore, the members can be solid, hollow, etc. and can be made of metal, plastic, or any other suitable material, including, but not limited to: copper pipe, polyvinyl chloride (PVC) pipe, steel tubing, etc. In an alternate embodiment, the frame 140 comprises a single elongated member extending from the joint mechanism 120 to the carriage 180. A lockable joint 150 can be incorporated in this alternate embodiment as well.

The second end of the frame 140 attaches to a carriage 180 via the carriage attachment device 170. In the embodiment illustrated in FIG. 1, the carriage attachment device 170 comprises two clamping devices 172 (although only one clamping device 172 is shown in FIG. 1). Each clamping device 172 is shaped so as to clamp onto a structural member 182 on each side of the carriage 180. Each clamping device 172 has a bolt 174 extending out to the side of the carriage 180, generally perpendicular to a line extending from the front to the rear of the carriage 180 and relatively close to the center of gravity of the carriage 180. The clamping devices 172 can be formed from cold-rolled steel and shaped so as to have an internal diameter slightly smaller than the structural members 182 when tightly clamped. A bolt and lock-nut assembly can be used to tighten the clamping devices 172.

Two carriage-attachment portions 148 (only one is shown in FIG. 1) of the frame 140 extend to either side of the carriage 180 and attach to the bolts 174 on the clamping devices 172. Removable lock-pins 176 can secure the carriage-attachment portions 148 of the frame 140 on the bolts 174. Bushings can be incorporated between the bolts 174 and the carriage-attachment portions 148 of the frame 140. The carriage-attachment portions 148 of the frame 140 can be configured so that they are able to rotate on the bushings, thereby allowing the frame 140 to move in an arc up and down. This configuration offers the caregiver 116 much more control over the carriage 180 while also stabilizing the carriage 180 and reducing the possibility of roll over.

In an alternate embodiment, the carriage attachment device 170 comprises two bolt and lock-pin assemblies wherein holes are drilled through the structural members 182 on each side of the carriage 180 and the bolts are inserted through the structural members 182 and through the carriage-attachment portions 148 of the frame 140. The lock pins are then inserted into/over the ends of the bolts thereby locking the frame 140 onto the bolts.

While in use, the apparatus 100 tends to flex and bounce, depending on the speed and movements of the walking/jogging caregiver 116. Although not shown in FIG. 1, shock absorbing components can be incorporated into the frame 140 to reduce sharp jolts and other unwanted motions that would otherwise be transmitted between the caregiver 116 and the carriage 180. Shock absorbing components include, but are not limited to, springs, telescoping frame components, shock absorbers, rubber pads, etc. Such components also have the advantage of reducing noises and vibrations.

FIG. 2 illustrates a top view of an exemplary embodiment of a hands-free towing apparatus 200. The primary components shown in FIG. 2 include: a belt-attachment device 210, a frame 240, and a carriage-attachment device 270.

As shown in the embodiment in FIG. 2, the belt-attachment device 210 is a padded belt 212 attached to a formed back-plate 214 that a caregiver 116 wears around his or her waist. The back-plate 214 can be ergonomically shaped so as to comfortably fit across the caregiver's 116 lower back.

The frame 240 attaches to the belt-attachment device 210 via a joint mechanism 220. In the embodiment shown in FIG. 2, the joint mechanism 220 comprises a bolt 222 and a rotatable member 224 extending perpendicular from the bolt 222 along a line extending in two directions. The rotatable member 224 can be a straight, cylindrically-shaped tube. Alternatively, the rotatable member 224 can be curved or otherwise shaped so that it does not extend along a line exactly but either approximates such or has a more three dimensional, plate-shaped form. Furthermore, the rotatable member 224 could be formed as a solid piece rather than as a hollow tube.

The bolt 222 is mounted on the belt-attachment device 210 and extends generally perpendicular relative to the plane of the caregiver's 116 back and away from the caregiver 116. The rotatable member 224 is mounted on the bolt 222 and can rotate in a plane perpendicular to the bolt 222. The rotatable member 224 attaches to the frame 240.

The frame 240 has a first end and a second end where the first end is connected to the joint mechanism 220 and the second end is attached to a carriage 280. In one embodiment, the first end of the frame 240 attaches to a rotatable member 224 of the joint mechanism 220. The frame 240 extends back from a caregiver 116 to a carriage 280. The frame 240 can be made so that it has a lockable joint 250 that allows the frame 240 to be folded for easy storage.

In the embodiment shown in FIG. 2, the frame 240 comprises two or more elongated tubular members 242 and 243 extending from the joint mechanism 220 parallel to each other and back towards the carriage 280. One or more horizontal stabilizers 245 can extend from one tubular member 242 to the other tubular member 243 to provide rigidity and support. The tubular members 242 and 243 can have a cross section that is round, square, rectangular, or any other shape. Furthermore, the members 242 and 243 can be solid, hollow, etc. and can be made of metal, plastic, or any other suitable material, including, but not limited to: copper pipe, polyvinyl chloride (PVC) pipe, steel tubing, etc.

The second end of the frame 240 attaches to a carriage 280 via the carriage attachment device 270. In the embodiment illustrated in FIG. 2, the carriage attachment device 270 comprises two clamping devices 272 and 273. Each clamping device 272 and 273 is shaped so as to clamp onto structural members 282 and 283 on each side of the carriage 280. Because the clamping devices 272 and 273 are adjustable, they will fit most structural members 282 and 283 on most carriages. However, the shape and size of structural members used in various carriages do vary considerably; therefore, an adapter kit can be used that contains various size and shape adapter rings which fit between the clamping devices 272 and 273 and the structural members. Each clamping device 272 and 273 has a bolt 274 and 275 extending out to the side of the carriage 280, generally perpendicular to a line extending from the front to the rear of the carriage 280 and relatively close to the center of gravity of the carriage 280. Two carriage-attachment portions 248 and 249 of the frame 240 extend to either side of the carriage 280 and attach to the bolts 274 and 275 on the clamping devices 272 and 273. Removable lock-pins 276 and 277 can secure the carriage-attachment portions 248 and 249 of the frame 240 on the bolts 274 and 275. The carriage-attachment portions 248 and 249 of the frame 240 can be configured so that they are able to rotate on the bolts 274 and 275, thereby allowing the frame 240 to move in an arc up and down.

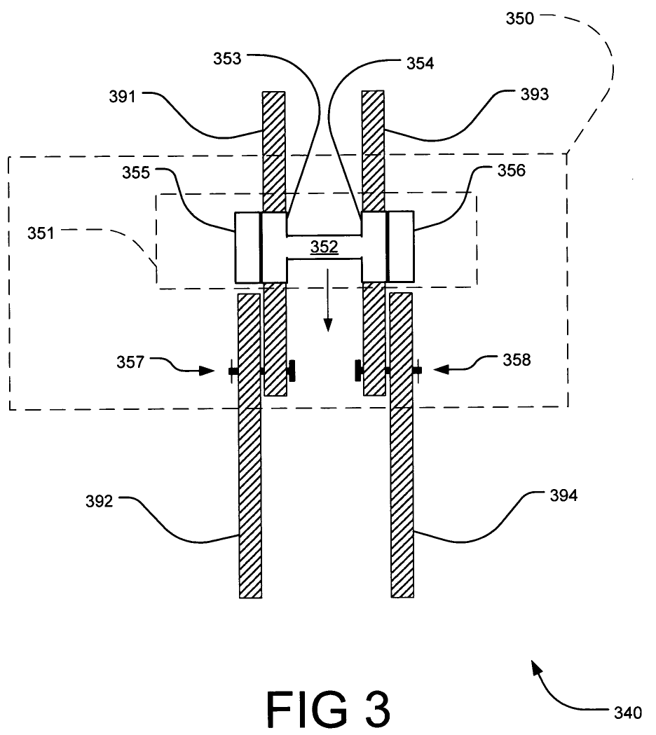

FIG. 3 illustrates a close-up, top view of a lockable joint 350 in a frame 340 of a hands-free towing apparatus for strollers, pet carriers and other carriages. The embodiment of a lockable joint 350 shown in FIG. 3 utilizes two joints 357 and 358 and an “H” shaped slider 351 having a cross-piece 352, two frame guides 353 and 354, and two frame locking guides 355 and 356. The slider 351 shown in FIG. 3 is “H” shaped, where the cross-piece 352 makes up the center bar of the “H” and the two frame guides 353 and 354 make up the two upright outer portions of the “H”.

In the embodiment illustrated in FIG. 3, the cross-piece 352 is a single horizontal member running perpendicular to the elongated tubular members, which are themselves comprised of two components each: an upper component 391 and a lower component 392 make up a first elongated tubular member and an upper component 393 and a lower component 394 make up a second elongated tubular member. Other embodiments could have only a single tubular member or multiple tubular members.

The first joint 357 attaches the first upper component 391 to the first lower component 392, while the second joint 358 attaches the second upper component 393 to the second lower component 394. As shown in FIG. 3, the joints 357 and 358 are simple bolt and lock-pin assemblies. Other types of joints are contemplated and are within the scope of the invention. The function of the joints 357 and 358 is to allow the upper components 391 and 393 to fold towards and rest next to the lower components 392 and 394.

The slider 351 is shown in FIG. 3 in the open, unlocked position. The first frame guide 353 and the second frame guide 354 are positioned over the upper component 391 of the first elongated tubular member and the upper component 393 of the second elongated tubular member. As can be seen in FIG. 3, the first frame locking guide 355 is attached to the first frame guide 353 and the second frame locking guide 356 is attached to the second frame guide 354.

When the slider 351 is slid downwards to lock the joint, the first frame locking guide 355 slides over the end of the lower component 392 of the first elongated tubular member and the second frame locking guide 356 slides over the end of the lower component 394 of the second elongated tubular member. Thus, effectively locking the upper components 391 and 393 relative to the lower components 392 and 394 and rendering the joints 357 and 358 non-functional (i.e., the joints 357 and 358 can no longer allow the upper components 391 and 393 to fold towards the lower components 392 and 394).

The lockable joint 350 allows the hands-free towing apparatus 100 to fold up for easy storage. Furthermore, it provides a flex-point to absorb some of the shocks and jolts that would otherwise be transmitted between the caregiver 116 and the carriage 180.

The above specification, examples and data provide a description of the structure and use of exemplary embodiments of the described articles of manufacture and methods. Many embodiments can be made without departing from the spirit and scope of the invention.

What is claimed is:

1. A hands-free towing apparatus for multiple carriages, comprising:
a belt-attachment device;
a joint mechanism;
a universal carriage-attachment device; and
a frame having a first end and a second end, wherein the first end of the frame is joined to the belt attachment device by the joint mechanism and the second end of the frame is attached to the carriage-attachment device.

2. The towing apparatus of claim 1, wherein the belt-attachment device comprises a back-plate and a means for securing the back-plate to a person's torso.

3. The towing apparatus of claim 2, wherein the joint mechanism comprises:
a bolt extending generally horizontally and perpendicularly from the back-plate; and
a rotatable member mounted on the bolt and able to rotate thereon.

4. The towing apparatus of claim 3, wherein the first end of the frame is attached to the rotatable member by a plurality of rotating joints, and the frame is oriented to extend generally perpendicular to the rotatable member.

5. The towing apparatus of claim 2, wherein the joint mechanism comprises a universal joint attached between the back-plate and the frame.

6. The towing apparatus of claim 4, wherein the frame incorporates a lockable joint.

7. The towing apparatus of claim 5, wherein the frame incorporates a lockable joint.

8. The towing apparatus of claim 6, wherein the lockable joint comprises:
a plurality of joints; and
a slider having a cross-piece, a plurality of frame guides, and a plurality of frame locking guides, and wherein the plurality of joints joins a bottom portion of the first end of the frame to a top portion of the second end of the frame and sliding the slider down the frame on the frame guides causes the frame locking guides to engage a top portion of the second end of the frame.

9. The towing apparatus of claim 7, wherein the lockable joint comprises:
a plurality of joints; and
a slider having a cross-piece, a plurality of frame guides, and a plurality of frame locking guides, and wherein the plurality of joints joins a bottom portion of the first end of the frame to a top portion of the second end of the frame and sliding the slider down the frame on the frame guides causes the frame locking guides to engage a top portion of the second end of the frame.

10. The towing apparatus of claim 4, wherein the universal carriage-attachment device comprises a clamping device shaped to attach to a structural member of a carriage, the clamping device having a bolt, and wherein the bolt attaches to a lower portion of the second end of the frame.

11. The towing apparatus of claim 5, wherein the carriage-attachment device comprises a clamping device shaped to attach to a structural member of a carriage, the clamping device having a bolt, and wherein the bolt attaches to a lower portion of the second end of the frame.

12. The towing apparatus of claim 8, wherein the carriage-attachment device comprises a clamping device shaped to attach to a structural member of a carriage, the clamping device having a bolt, and wherein the bolt attaches to a lower portion of the second end of the frame.

13. The towing apparatus of claim 9, wherein the carriage-attachment device comprises a clamping device shaped to attach to a structural member of a carriage, the clamping device having a bolt, and wherein the bolt attaches to a lower portion of the second end of the frame.
